(19) United States
(12) Patent Application Publication
(10) Pub. No.: US 2020/0237587 A1
(43) Pub. Date: Jul. 30, 2020

(54) MOTORIZED WHEELCHAIR AND CONTROL METHOD THEREOF

(71) Applicant: LG ELECTRONICS INC., Seoul (KR)

(72) Inventors: Haemin CHOI, Seoul (KR); Wondong DO, Seoul (KR); Daekeun YOON, Seoul (KR); Jaebeom IM, Seoul (KR); Induk CHOI, Seoul (KR)

(21) Appl. No.: 16/714,994

(22) Filed: Dec. 16, 2019

(30) Foreign Application Priority Data
Jan. 29, 2019 (KR) 10-2019-0011288

(51) Int. Cl. A61G 5/04; A61G 5/10

(52) U.S. Cl. CPC A61G 5/048; A61G 5/1005; A61G 5/1051; A61G 2203/70; A61G 2203/14; A61G 2203/40; A61G 2203/16

(57) ABSTRACT

A method of controlling a motorized wheelchair according to an embodiment, the motorized wheelchair including a seat frame provided with a seat for seating of a user, a back frame provided with a backrest for supporting the user's back and detachably connected to the seat frame, and main wheels connected to a lower end of the back frame, may include inputting a reverse command to an input unit, outputting an image photographed by a rear camera installed in the back frame to an output unit, detecting, by a rear height difference sensor installed in bottom of the back frame, a height difference in the ground, determining whether the height difference detected by the rear height difference sensor is larger than or equal to a preset reference height difference, performing an emergency braking defined as activating a brake of the main wheels when the detected height difference is larger than or equal to the reference height difference, and outputting a warning about the detected height difference to the output unit.

### CROSS-REFERENCE TO RELATED APPLICATIONS

The present application claims priority under 35 U.S.C. 119 and 35 U.S.C. 365 to Korean Patent Application No. 10-2019-0011288, filed in Korea on Jan. 29, 2019, which is hereby incorporated by reference in its entirety.

### BACKGROUND OF THE INVENTION

### 1. Field of the Invention

The present disclosure relates to a motorized wheelchair and a control method thereof.

### 2. Discussion of the Related Art

A motorized wheelchair equipped with an electric motor has been provided as an apparatus for assisting people with difficulty in walking such as the disabled and the elderly. The electric motor is generally called a motor. In addition, the motor provides a driving force to drive the motorized wheelchair.

In a conventional motorized wheelchair, since the volume and weight occupied by the motor are relatively large, there is a problem in that the motorized wheelchair is difficult to ride the vehicle and is inconvenient to be stored.

In order to solve those problems, Korean Patent Publication No. 2002-0063053 (hereinafter referred to as prior art document 1) published on Aug. 1, 2002 discloses a wheelchair in which a small DC motor or a brushless (DC) motor is connected to each of wheels to reduce the volume of a driving device and the wheelchair is capable of being folded and a driving control method thereof.

However, since the prior art document 1 merely discloses a technique for minimizing the size of the motor and controlling the running speed of each wheel, there is a limit to minimize the volume of the motorized wheelchair. In addition, according to the prior art document 1, the motorized wheelchair has a structure that is still difficult to be disassembled and therefore, there is a problem of low installation convenience.

In addition, considering the characteristics of a user who uses a motorized wheelchair in general, the motorized wheelchair should be able to assist the user's ability to recognize a risk. Therefore, the motorized wheelchair needs to be provided with various and precise risk detection means and recognition means for the user's safety compared to general walk assistance devices.

However, Prior Art document 1 has a problem that it does not disclose any means and methods capable of assisting the user's ability to recognize risk.

In order to solve such a problem, Korean Patent Publication No. 10-2011-0118965 (hereinafter, referred to as Prior Art document 2) published on Nov. 2, 2011 discloses an autonomous wheelchair system using gaze recognition, which allows a user to operate the motorized wheelchair using the gaze of the user with inconvenient behavior.

The prior art document 2 discloses a technique for adjusting the motorized wheelchair through recognition of the user's gaze by detecting the user's pupil. In addition, the prior art document 2 discloses an ultrasonic sensor module for detecting an obstacle and an autonomous driving mode for controlling movement based on a result of detection by the ultrasonic sensor module.

On the other hand, considering the general characteristics of the user using the motorized wheelchair, the motorized wheelchair needs to quickly grasp the surrounding running environment during running. In other words, the motorized wheelchair needs to able to accurately detect a risk factor while running and inform a user of the risk factor.

When the motorized wheelchair does not detect a risk factor such as a height difference of the ground, an obstacle in the front and rear directions, or the like, it may lead to a big accident while running. In addition, when unnecessary malfunction occurs as a result of inaccurate sensing, it may cause great inconvenience to the user.

However, in the prior art document 2, the motorized wheelchair is merely controlled based on risk perception through the user's gaze while autonomous driving is being performed as a result of detection by a plurality of ultrasonic sensors, so that the motorized wheelchair cannot detect various risk factors centered on users, such as a height difference (or step) of the running ground and there is a problem that the recognition of risks during autonomous driving depends only on the recognition contents of the users.

In addition, according to the prior art document 2, there is a problem that there is no way to enable the user having a variety of inconveniences to recognize the risk. Due to this, a user who has a limited ability in the cognitive ability, such as a visually impaired or a hearing impaired, has difficulty in recognizing a risk when using a motorized wheelchair.

In addition, in the prior art document 2, ten ultrasonic sensors are provided as a method for improving an obstacle detection capability. However, as the use of a plurality of sensors increases the manufacturing cost, it is difficult to provide a more economical motorized wheelchair.

### SUMMARY OF THE INVENTION

The present disclosure is to solve the above problems, and an object of the present disclosure is to provide a motorized wheelchair which enables easy disassembly and installation and minimize volume when not in use and a control method thereof.

In addition, an object of the present disclosure is to provide a motorized wheelchair which are provided with various risk detecting means and user recognition means to enable the user of the motorized wheelchair to accurately recognize and avoid a risk, and a control method thereof.

In addition, an object of the present disclosure is to provide a motorized wheelchair capable of enabling a user to recognize a detected risk by variously stimulating the user's senses such as sight, hearing, and tactile sense, and a control method thereof.

In addition, an object of the present disclosure is to provide a motorized wheelchair which assists a user in perceiving a risk of a rear area and a control method thereof.

To achieve the above objects, a motorized wheelchair may include a seat assembly on which a user is able sit, a seat frame supporting the seat assembly, a back frame detachably connected to both sides of the seat frame, a control box located in an inner space formed by a lower portion of the back frame, main wheels respectively connected to both lower ends of the back frame, a rear obstacle detecting sensor installed at a rear of the control box, and a rear height difference sensor installed on the back frame to be inclined upward toward the ground.

Furthermore, the back frame may include an upper frame to which a backrest is connected in front thereof, side frames extending to be inclined downward from both side ends of the upper frame and a low frame connecting lower ends of the side frames and installed with the rear height difference sensor.

Furthermore, the low frame extends such that a rear end is higher than a front end.

Furthermore, the motorized wheelchair may further include a rear camera installed on a rear surface of the upper frame.

Furthermore, the side frames may be formed with an insertion groove for guiding insertion of the seat frame.

Furthermore, the side frame may be located under the insertion groove and include a curved portion extending inward to form a space in which the main wheel is mounted.

Furthermore, the motorized wheelchair may further include armrests rotatably connected to both sides of the back frame, and an input unit and an output unit detachably installed to the armrests.

Furthermore, the input unit may be provided with a vibrating device therein and include a control stick for operating movement.

Furthermore, the output unit may include a display that provides a screen and a speaker that provides a sound.

Furthermore, the motorized wheelchair may further include a light emitting case installed on the rear surface of the control box to cover the rear obstacle detecting sensor and provided with a light emitting diode.

Furthermore, the rear height difference sensor may be located at a most rear of the back frame.

According to another aspect, to achieve the above objects, a method of controlling a motorized wheelchair according to an embodiment, the motorized wheelchair including a seat frame provided with a seat for seating of a user, a back frame provided with a backrest for supporting the user's back and detachably connected to the seat frame, and main wheels connected to a lower end of the back frame, may include inputting a reverse command to an input unit, outputting an image photographed by a rear camera installed in the back frame to an output unit, detecting, by a rear height difference sensor installed in bottom of the back frame, a height difference in the ground, determining whether the height difference detected by the rear height difference sensor is larger than or equal to a preset reference height difference, performing an emergency braking defined as activating a brake of the main wheels when the detected height difference is larger than or equal to the reference height difference, and outputting a warning about the detected height difference to the output unit.

Furthermore, the input unit may include a control stick for controlling running and a plurality of input buttons.

Furthermore, the output unit may include a display that provides a screen, a speaker that provides a sound, and a vibrating device provided in the control stick.

Furthermore, the warning may be output by at least one of the display, the speaker and the vibrating device.

Furthermore, the outputting of the warning may include a warning screen to the display, a warning sound output to the speaker, a speech guidance and a vibration by the vibrating device.

Furthermore, the method may further include determining whether a user confirmation or forward is input for running straight after output of the warning.

Furthermore, the method may further include releasing operation of the break when the user confirmation or forward is input.

Furthermore, the method may further include detecting an obstacle by an obstacle detecting sensor installed on a rear surface of a control box connected to the back frame, determining whether the detected obstacle is positioned within a preset first distance, and outputting a warning for the detected height difference to the output unit when the detected obstacle is within the first distance.

Furthermore, the method may further include changing the output warning when the detected obstacle is within a second distance shorter than the first distance.

According to the present disclosure, it is possible to store the motorized wheelchair in a relatively small loading space.

In addition, since the motorized wheelchair is easily disassembled into two parts, it is easy to carry the motorized wheelchair when not in use.

In addition, the disassembled two parts may be fitted into each other to be stored as one body, thus minimizing the total volume, and facilitating management.

In addition, the disassembled two parts may be easily connected to each other, thereby improving convenience in installation.

In addition, it is possible to accurately detect a variety of risk factors, such as dangerous obstacles, the road surface environment during running of the motorized wheelchair, and enable a user to recognize the detected risk in various ways, thereby improving running safety and reliability.

In addition, it is possible to detect a height difference (or a step) of the running surface along the running path, thereby preventing an accident such as an overturning of the motorized wheelchair and a fall of the user in advance.

In addition, when an environment that may pose a risk to the user is detected, the control of the motorized wheelchair to prevent an accident is first provided in advance, and secondly, the control according to the confirmation of the user is provided, thereby minimizing user inconvenience while performing safe running.

In addition, it is possible to improve the safety by detecting a risk that the user does not recognize when reversing the motorized wheelchair.

### BRIEF DESCRIPTION OF THE DRAWINGS

FIG. 1 is a front perspective view showing a motorized wheelchair according to an embodiment of the present disclosure.

FIG. 2 is a rear perspective view showing a motorized wheelchair according to an embodiment of the present disclosure.

FIG. 3 is a front perspective view showing a back frame and a control box according to an embodiment of the present disclosure.

FIG. 4 is a perspective view showing a state in which a motorized wheelchair is disassembled according to an embodiment of the present disclosure

FIG. 5 is a block diagram showing a control configuration of a motorized wheelchair according to an embodiment of the present disclosure.

FIG. 6 is a flow chart showing a height difference risk prevention control for a motorized wheelchair according to an embodiment of the present disclosure.

FIG. 7 is a flow chart showing rear obstacle risk prevention control of the motorized wheelchair according to an embodiment of the present disclosure.

### DETAILED DESCRIPTION OF THE PREFERRED EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s).

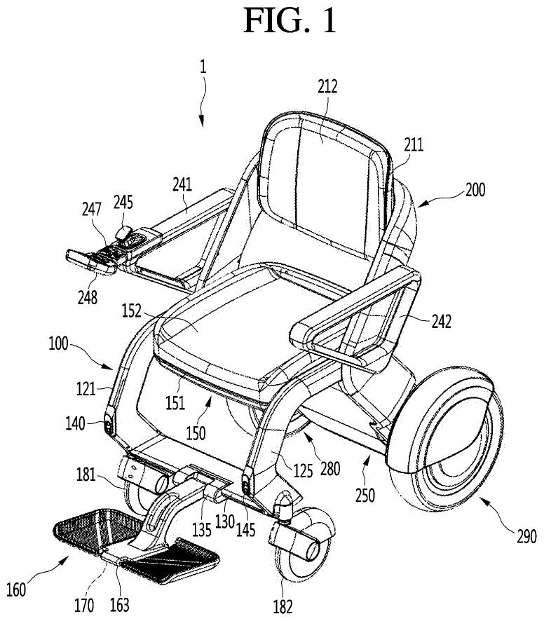

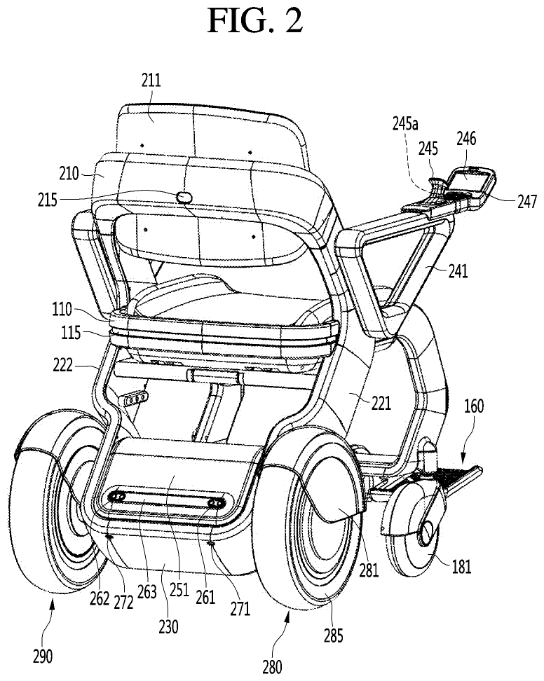

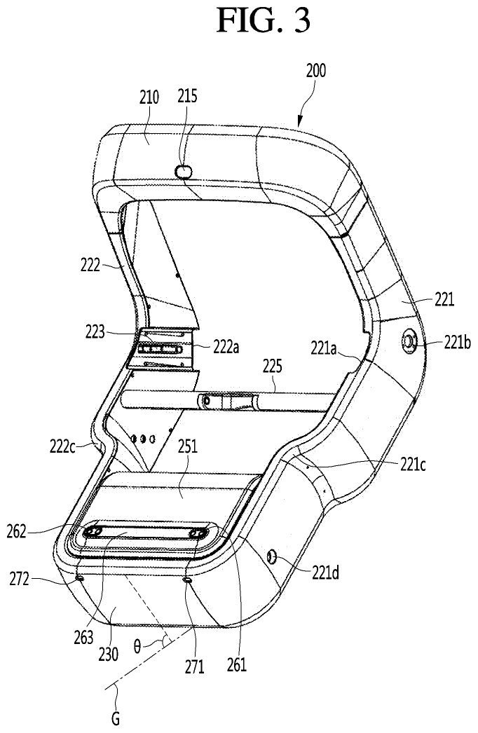

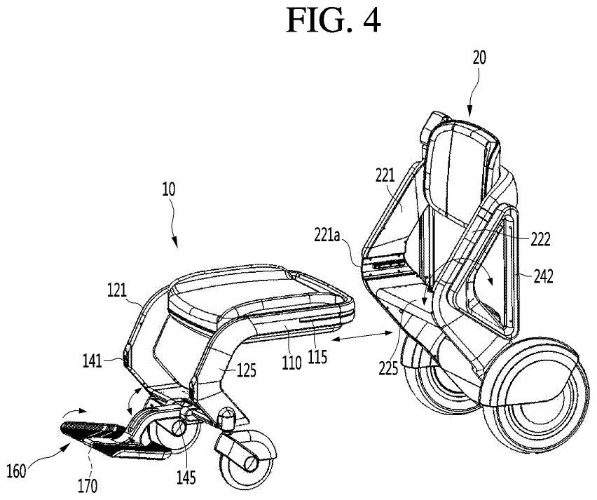

FIG. 1 is a front perspective view showing an motorized wheelchair according to an embodiment of the present disclosure, FIG. 2 is a rear perspective view showing an motorized wheelchair according to an embodiment of the present disclosure, FIG. 3 is a front perspective view showing a back frame and a control box according to an embodiment of the present disclosure, and FIG. 4 is a perspective view showing a state in which a motorized wheelchair is disassembled according to an embodiment of the present disclosure.

FIGS. 1 to 4, a motorized wheelchair 1 according to an embodiment of the present disclosure may include a seat frame 100, front obstacle detecting sensors 140 and 145 installed on the seat frame 100, a foot guide 160 to be rotatably connected to the seat frame 100, sub-wheels 181, 182 connected to the seat frame 100 to guide driving, and a seat assembly 150 supported by the seat frame 100.

The seat frame 100 may form a frame to which the seat assembly 150 is connected therein. That is, the seat frame 100 may form a space in which the seat assembly 150 is mounted.

The seat frame 100 may extend to form a closed curve in which both ends thereof coincide each other. For example, the seat frame 100 may have a shape of when viewed from the side.

The seat frame 100 may include a rear frame 110, leg frames 121 and 125 respectively extending forward from both side ends of the rear frame 110, and a front frame 130 connected to lower ends of the leg frames 121 and 125.

That is, the rear frame 110 may form a rear portion of the seat frame 100, the leg frames 121 and 125 may form both side portions of the seat frame 110, and the front frame 130 may form a front portion of the seat frame 100.

The rear frame 110 may extend in a lateral direction to cover the rear surface of the seat assembly 150.

The leg frames 121 and 125 may extend forward from the both side ends of the rear frame 110 to cover both side surfaces of the seat assembly 150.

The leg frames 121 and 125 may include a first leg frame 121 extending from one side end of the rear frame 110 and a second leg frame 125 extending from the other side end of the rear frame 110.

For example, the first leg frame 121 may extend from a right end of the rear frame 110, and the second leg frame 125 may extend from a left end of the rear frame 110. Therefore, the first leg frame 121 may be laterally spaced apart from the second leg frame 125.

The first leg frame 121 and the second leg frame 125 may be formed in the same shape. That is, the first leg frame 121 and the second leg frame 125 may be formed to be symmetrical with each other.

In addition, the leg frames 121 and 125 may extend to be bent a plurality of times. In other words, each of the leg frames 121 and 125 may extend such that the extending direction thereof is changed at least one or more times

That is, the leg frames 121 and 125 may extend forward and then downward. For example, the leg frames 121 and 125 may have a shape of an approximately ‘┌’ when viewed from the side.

As a result, upper portions of the leg frames 121 and 125 may extend forward to support the seat assembly 150. The lower portions of the leg frames 121 and 125 may be connected to the front frame 130 to support the foot guide 160.

Furthermore, the leg frames 121 and 125 may have an approximately ‘hook’ shape when viewed from the side. As another example, the front portions of the leg frames 121 and 125 may have a shape of ‘leg with knee bent’ or ‘<’ when viewed from the side.

In addition, front ends of the leg frames 121 and 125 may be positioned at the most forward portion of the seat frame 100. As a result, the front ends of the leg frames 121 and 125 may be understood as the front end of the seat frame 100.

A cutout groove 126 may be formed at the front ends of the leg frames 121 and 125. The front obstacle detecting sensors 140 and 145 may be installed in the cutout groove 126.

The front obstacle detecting sensors 140 and 145 may include an ultrasonic sensor (USS). Furthermore, the front obstacle detecting sensors 140 and 145 may further include an ultrasonic sensor capable of detecting a change in distance.

Accordingly, since the front obstacle detecting sensors 140 and 145 are able to detect how much a distance to an obstacle in front thereof vary, it is possible to perform control to raise a warning level to the user as the distance between the obstacle and the motorized wheelchair 1 becomes closer.

The front obstacle detecting sensors 140 and 145 may be installed at the front ends of the leg frames 121 and 125. That is, the front obstacle detecting sensors 140 and 145 may be connected to the front end of the seat frame 100.

In addition, the front obstacle detecting sensors 140 and 145 may include a first front obstacle detecting sensor 140 connected to the first leg frame 121, and a second front obstacle detecting sensor 145 connected to the second leg frame 125.

As a result, since the front obstacle detecting sensors 140 and 145 are installed at the forefront of the seat frame 100, an obstacle detecting range may be extended to the maximum in the running direction of the motorized wheelchair 1. That is, the front obstacle detecting sensors 140 and 145 may be installed to minimize interference with other components.

The rear portions of the leg frames 121 and 125 may be slidably inserted into a back frame 200. In detail, the rear portion of the first leg frame 121 and the rear portion of the second leg frame 125 may be slidably inserted into or slidably drawn out an insertion groove 221a formed on an inner surface of the back frame 200.

To this end, the leg frames 121 and 125 may include a slide groove 115 for guiding coupling with the back frame 200.

The slide groove 115 may be recessed inward from the outer surfaces of the leg frames 121 and 125. The slide groove 115 may extend in a straight line toward the rear ends of the leg frames 121 and 125.

Of course, the slide groove 115 may extend from the first leg frame 121 to the second leg frame 125 via the rear frame 110.

A slide guide 223 formed in an insertion grooves 221a or 222a to be described later may be inserted into the slide groove 115. As the slide guide 223 inserted into the slide groove 115 moves forward or backward, the seat frame 100 may be easily separated from or connected to the back frame 200.

The leg frames 121 and 125 may further include wheel coupling parts 124 and 129 to which the sub wheels 181 and 182 for driving of the motorized wheelchair 1 are connected.

The wheel coupling parts 124 and 129 may be formed at the lower ends of the outer surfaces of the leg frames 121 and 125.

In more detail, the wheel coupling parts 124 and 129 may include a first wheel coupling part 124 formed in the first leg frame 121 and a second wheel coupling part 129 formed in the second leg frame 125.

The first wheel coupling part 124 may be located at the lower end of the outer surface of the first leg frame 121. Similarly, the second wheel coupling part 129 may be located at the lower end of the outer surface of the second leg frame 125.

That is, the sub wheels 181 and 182 may be connected to the lower end of the seat frame 100 to enable a rolling motion.

The sub wheels 181 and 182 may be subordinate to the main wheels 280 and 290 that provide a driving force, which will be described later to perform the rolling motion. That is, the sub wheels 181 and 182 may guide the driving of the motorized wheelchair 1 by assisting the main wheels 280 and 290. For example, the sub wheels 181 and 182 may include casters. Of course, the sub wheels 181 and 182 may be provided with a separate driving device.

The sub wheels 181 and 182 may include a first sub wheel 181 connected to one of the leg frames 121 and 125 to perform the rolling motion and a second wheel 182 connected to the other of the leg frames 121 and 125 to perform the rolling motion.

In detail, the first sub wheel 181 may be connected to the first wheel coupling part 124. The second sub wheel 182 may be connected to the second wheel coupling part 124. That is, the first sub wheel 181 may be positioned to be spaced apart from the second sub wheel 182 in a lateral direction. Therefore, since the first sub wheel 181 and the second sub wheel 182 support both lower ends of the seat frame 100, the motorized wheelchair 1 may stably drive together with the main wheels 280 and 290.

The front frame 130 may be connected to the lower ends of the leg frames 121 and 125. For example, the front frame 130 may extend from the lower end of the first leg frame 121 to the lower end of the second leg frame 125. Here, the front frame 130 may be located inside the leg frames 121 and 125, and the wheel coupling parts 124 and 129 may be located outside the leg frames 121 and 125.

The front frame 130 may extend in both directions to connect the lower ends of the first leg frame 121 and the second leg frame 125.

The front end of the front frame 130 may be located behind the front ends of the leg frames 121 and 125. Therefore, the obstacle detecting sensors 140 and 145 installed at the front ends of the leg frames 121 and 125 may detect an obstacle without interference with the front frame 130.

The front frame 130 may include a hinge part 135 to which the foot guide 160 is able to be rotatably connected.

The hinge part 135 may be formed at the front end of the front frame 130. In addition, the hinge part 135 may be recessed backward from the center portion of the front end of the front frame 130 to form a space in which the foot guide 160 is installed.

That is, the foot guide 160 may be rotatably connected to the front frame 130. In addition, the foot guide 160 may be rotatably connected to rotate upward of the hinge part 135 (see arrow in FIG. 4).

In addition, the two footrests provided on the foot guide 160 to support both feet of the user may be formed to be rotatable in a direction facing each other.

In more detail, the foot guide 160 may include a rotating shaft (not shown) connected to the hinge part 135, a rotating plate 163 connected to the rotating shaft and extending forward and footrests connected to the both sides of the rotating plate 163 to support both feet of the user.

The footrests may be connected to side ends of the rotating plate 163 to rotate (see the arrow in FIG. 4).

The seat assembly 150 may include a base plate 151 connected to the seat frame 100, a seat 152 installed on an upper surface of the base plate 151, a battery (not shown) that provides power, and a battery cover extending downward from the base plate 151 to accommodate the battery.

The base plate 151 may be connected to upper portions of the leg frames 121 and 125. In detail, the base plate 151 may be provided such that an upper portion of the first leg frame 121 and an upper portion of the second leg frame 125 are connected to each other. For example, the second base plate 151 may extend from an inner surface of the first leg frame 121 extending in a straight line from the rear frame 110 to an inner surface of the second leg frame 125 extending in a straight line from the rear frame 110.

That is, the base plate 151 may extend to shield an inner upper space formed by the rear frame 110, the first leg frame 121, and the second leg frame 125.

The seat 152 may be located over the base plate 151. The seat 152 may be formed of a fabric. For example, the seat 152 may be made of a soft and resilient material such that the user is able to sit comfortably.

The battery may be located below the base plate 151. The battery may supply power to the electronic parts of the motorized wheelchair 1, such as drive motors 283 and 293 provided in the main wheels 280 and 293, various board PCBs, inverters and converters provided in the control box 250, a control stick 245 for controlling driving, a display 246, an input button 247 and the like.

The battery may supply power to the electronic parts only when the seat frame 100 is connected to the back frame 200.

The battery cover may extend downward along the circumference of the base plate to cover the battery from below. That is, the battery cover may be connected to the lower side of the base plate 151, and the battery may be installed in an inner space formed by the battery cover 154 and the base plate 151.

On the other hand, the motorized wheelchair 1 may further include a front height difference sensor 170 capable of detecting the height difference of a running ground.

Hereinafter, the ground on which the motorized wheelchair 1 drives may be referred to as a “running surface”.

The front height difference sensor 170 may include an infrared position sensitive device (PSD).

The front height difference sensor 170 may be installed in the foot guide 160. In detail, the front height difference sensor 170 may be connected to the front portion of the foot guide 160 so as to face the ground.

In addition, the foot guide 160 may be disposed to be inclined upwardly from the running surface (or the ground) to maximize the performance of the front height difference sensor 170.

The foot guide 160 may be located in front of the sub wheels 181 and 182. Therefore, the front height difference sensor 170 may detect a height difference (step) of the driving surface that has not yet reached along the driving direction of the motorized wheelchair 1.

The motorized wheelchair 1 may further include a back frame 200 that is detachably connected to the seat frame 100, a back plate 211 connected to the back frame 200 to support the user's back and a cushion 121.

The cushion 212 may be formed of the same material as the seat 152. The back plate 211 may be connected to the rear side of the cushion 212.

The back plate 211 may be integrally connected with the cushion 212. Thus, the back plate 211 and the cushion 212 may be referred to as a “backrest”.

The back plate 211 may be connected to the front surface of the back frame 200. Here, the back plate 211 and the cushion 212 may be positioned higher than the seat 152.

The back frame 200 may form a frame into which the seat frame 100 is vertically inserted, on the inside thereof. That is, the back frame 200 may form a space that is open in the front and rear direction by the width in the direction of both sides of the seat frame 100 such that the seat frame 100 is able to be slidably inserted into the inner surface.

The back frame 100 may extend to form a closed curve in which both ends thereof coincide each other. For example, the back frame 200 may have a shape of ‘<’ when viewed from the side.

The back frame 200 may include an upper frame 210, side frames 221 and 222 extending downward from both side ends of the upper frame 210, and a low frame 230 connected to lower ends of the side frames 221 and 222.

The upper frame 210 may form an upper portion of the back frame 200, the side frames 221 and 222 may form both side portions of the back frame 200, and the low frame 230 may form a lower portion of the back frame 200.

The motorized wheelchair 1 may further include a rear camera 215 installed in the upper frame 210.

The rear camera 215 may be installed in the upper frame 210 such that lens is exposed to the rear. For example, the rear camera 215 may be installed in a rear surface of the upper frame 210. Accordingly, the rear camera 215 may photograph the rear of the motorized wheelchair 1.

The rear camera 215 may provide a rear image of the motorized wheelchair 1 to a display 246 which will be described later. For example, when the user presses a button provided on the input button 247, the user may see the image provided by the rear camera 215 on the display 246.

The upper frame 210 may extend in both directions to cover the back plate 211 from the rear.

The side frames 221 and 222 may extend downward from both side ends of the upper frame 210.

In detail, the side frames 221 and 222 may include a first side frame 221 extending from one side end of the upper frame 210 and a second side frame 222 extending from the other side end of the upper frame 210.

For example, the first side frame 221 may extend from a right end of the upper frame 210, and the second side frame 222 may extend from a left end of the upper frame 210. Therefore, the first side frame 221 may be laterally spaced apart from the second side frame 222.

The first side frame 221 and the second side frame 222 may be formed in the same shape. That is, the first side frame 221 and the second side frame 222 may be formed to be symmetrical with each other.

In addition, the side frames 221 and 222 may extend such that the extending direction thereof is changed at least one or more times.

In detail, the side frames 221 and 222 may extend to be downwardly inclined forward from the both side ends of the upper frame 210 to a point at which the seat frame 100 is connected, and extend to be downwardly inclined rearward from the point at which the seat frame 100 is connected. For example, the side frames 221 and 222 may have a shape of substantially ‘<’ when viewed from the side.

According to this, the coupling of the seat frame 100 and the back frame 200 is relatively close to the center of gravity of the motorized wheelchair 1, thus achieving a more stable coupling. In addition, the seat 152 and the cushion 212 may be provided at an angle at which the hip and back of the user are comfortably supported, thus achieving a more human-friendly comfort.

The side frames 221 and 222 may be formed with insertion grooves 221a and 222a into which the seat frame 100 is inserted.

The outer surfaces of the leg frames 121 and 125 may be slidably inserted into the insertion grooves 221a and 222a. For example, the insertion grooves 221a and 222a may be formed such that the leg frames 121 and 125 are fitted thereto in the front and rear direction.

That is, the insertion grooves 221a and 222a may be formed at a point where the side frames 221 and 222 and the seat frame 100 are connected to each other.

The insertion grooves 221a and 222a may be formed to be outwardly recessed in the inner surfaces of the side frames 221 and 222. The insertion grooves 221a and 222a may be formed such that a recessed space extends in the front-rear direction. For example, the insertion groove 221 may be formed such that the recessed space extends from the front end to the rear end in the center portion of the side frames 221 and 222.

The insertion groove 221a formed in the first side frame 221 may be referred to as a first insertion groove 221a, and the insertion groove 222a formed in the second side frame 222 may be referred to as a second insertion groove.

An outer surface of the first leg frame 121 may be slidably inserted into the first insertion groove 221a, and an outer surface of the second leg frame 125 is slidably inserted into the second insertion groove 222a.

The side frames 221 and 222 may further include a slide guide 223 positioned in the insertion grooves 221a and 222a and protruding from the inner surfaces of the side frames 221 and 222.

The slide guide 223 may include a first slide guide 223 located in the first insertion groove 221a and a second slide guide (not shown) located in the second insertion groove 222a.

The slide guide 223 may be inserted into the slide groove 115 formed in the leg frames 121 and 125. That is, the slide guide 223 and the slide groove 115 may guide the leg frames 121 and 125 to be connected to the insertion groove 221a.

The slide guide 223 may be formed to have a shape corresponding to the slide groove 115. For example, the slide guide 223 may protrude inward from the slide groove 115. The slide guide 223 may extend in the front-rear direction.

The back frame 200 may further include a guide plate 225 supporting a lower portion of the seat assembly 150.

The guide plate 225 may be located below the insertion grooves 221a and 222a. The guide plate 225 may be formed to support the bottom surface of the seat assembly 150 when the seat frame 100 is connected to the back frame 200.

In detail, the guide plate 225 may extend in both directions such that the center portion of the first side frame 221 and the center portion of the second side frame 222 are connected to each other.

In addition, a lower portion of the side frame 221 or 222 may form a space to protect the upper portion of the main wheel 280 or 290.

In detail, the side frames 221 and 222 may include curved portions 221c and 222c positioned below the guide plate 225.

The curved portions 221c and 222c may be defined as portions in which lower portions of the side frames 221 and 222, extending to be inclined backwards, extend to be bent inward.

The curved portions 221c and 222c may include a first curved portion 221c formed in the first side frame 221 and a second curved portion 222c formed in the second side frame 222.

The first curved portion 221c and the second curved portion 222c may form curved surfaces that are bent in a direction facing each other.

Accordingly, the side frames 221 and 222 may form a space in which the main wheels 280 and 290 are capable of being more stably connected by the curved portions 221c and 222c.

The side frames 221 and 222 may extend to be inclined downward from the curved portions 221c and 222c to cover both side surfaces of the control box 250.

The side frames 221 and 222 may further include main wheel coupling holes 221d positioned below the curved portions 221 and 222c.

A wheel shaft supporting the main wheels 280 and 290 may pass through the main wheel coupling holes 221d. That is, the main wheel coupling holes 221d may be formed as openings that are open in both directions.

The main wheels 280 and 290 may be connected to the side frames 221 and 222 by the main wheel coupling holes 221d.

The main wheel coupling holes 221d may include a first main wheel coupling hole 221d formed in the first side frame 221 and a second main wheel coupling hole formed in the second side frame 222 (not shown).

In addition, the side frames 221 or 222 may further include an armrest coupling hole 221b to which the armrest 241 or 242 is rotatably connected.

The armrest coupling hole 221b may include a first armrest coupling hole 221b formed on the outer surface of the first side frame 221 so as for the first armrest 241 to be connected thereto, and a second armrest coupling hole (not shown) formed on the outer surface of the second side frame 222 so as for the second armrest 242 to be connected thereto.

The armrest coupling hole 221b may be formed as an opening through which that the axes of the armrests 241 and 242 pass.

The low frame 230 may be connected to lower ends of the side frames 221 and 222. In detail, the low frame 230 may extend from the lower end of the first side frame 221 to the lower end of the second side frame 222. That is, the low frame 230 may extend in both directions to connect the lower end of the first side frame 221 and the lower end of the second side frame 222.

In addition, the low frame 230 may be disposed to be inclined to have a predetermined angle in the front-rear direction. That is, the low frame 230 may extend to be inclined with the ground in the front-rear direction.

In detail, the rear end of the low frame 230 may be located higher than front end of the low frame 230. That is, the low frame 230 may extend to be inclined upward from the front end to the rear.

Referring to FIG. 3, the low frame 230 may extend to have a predetermined angle θ based on a virtual reference line G parallel to the ground. The predetermined angle may be set to an acute angle. For example, the inclined surface of the low frame 230 may be formed to have an angle with the running surface at an angle of 0˜60°.

On the other hand, the low frame 230 may be installed with rear height difference sensors 271, 272 that sense the ground (or running surface). For example, the rear height difference sensors 271 and 272 may be installed at the rear end of the low frame 230 to face the ground. That is, the rear height difference sensors 271 and 272 may be installed on the bottom surface of the back frame 200 so as to be located at the most rear of the back frame 200.

When the inclined surface of the low frame 230 has an angle greater than an acute angle with the running surface, an area sensed by the rear height difference sensors 271 and 272 may exceed an allowable range. Accordingly, a factor other than a running surface is recognized, and a problem, such as mis-perception, may be caused. As a result, in order to optimize the performance of the rear height difference sensors 271 and 272, the inclined surface of the low frame 230 may extend to be inclined to have an acute angle with the running surface.

That is, the low frame 230 may be formed with an extension surface positioned along an imaginary extension line E extending from the imaginary reference line G at the predetermined angle θ.

In summary, the low frame 230 may extend to connect the side frames 221 and 222 in both directions, and may extend to be inclined such that the front end is located below the rear end in the front-rear direction.

Therefore, the sensing ranges of the rear height difference sensors 271 and 272 installed in the low frame 230 may be further expanded to the rear. In addition, when the motorized wheelchair 1 moves backward, the rear height difference sensors 271 and 272 may identify a height difference with respect to the running surface (or the ground) even at a farther distance. Therefore, it is possible to improve running safety even at a relatively high speed.

The motorized wheelchair 1 may further include the rear height difference sensor 271 and 272 installed on the bottom of the back frame 200, the control box 250 provided with a plurality of electronic parts, the rear obstacle detecting sensors 261 and 262 installed in the control box 250, and the main wheels 280 and 290 positioned at both lower ends of the side frames 221 and 222.

The rear height difference sensors 271 and 272 may be connected to the low frame 230 so as to face the ground (or the running surface).

The rear height difference sensors 271 and 272 may detect the height difference with respect to the rear ground of the motorized wheelchair 1. Accordingly, the motorized wheelchair 1 may stop running or guide the user to run on a different route when the height difference detected by the rear height difference sensors 271 and 272 is higher than a reference, protecting the user from an accident such as overturning or falling.

The rear height difference sensors 271 and 272 may include an infrared position sensitive device (PSD).

The rear height difference sensors 271 and 272 may be provided in plurality. For example, the rear height difference sensors 271 and 272 may include a first rear height difference sensor 271 and a second rear height difference sensor 272 spaced apart laterally from the first rear height difference sensor 271.

On the other hands, the rear height difference sensor 271 or 272 may be provided to have the same configuration as the front height difference sensor 170.

The control box 250 may be installed at the lower portion of the back frame 200. [symbol] . Specifically, the control box 250 may be supported by the inner surfaces of the side frames 221 and 222 and the inner surfaces of the low frame 230. The low frame 230 may form a surface supporting the control box 250.

The control box 250 may be disposed in an inner space in which the lower portion of the back frame 200 is formed. The control box 250 may be connected to the inner surface and bottom surface of the back frame 200.

The control box 250 may be provided with a plurality of electronic parts therein. For example, the plurality of electronic parts may include an inverter, a converter, a microcomputer, a main board, a plurality of PCBs, or the like.

In addition, the plurality of electronic parts provided in the control box 250 may be electrically connected to the components of the motorized wheelchair 1. Therefore, the plurality of electronic parts may constitute a controller 300 for controlling the operation of the motorized wheelchair 1.

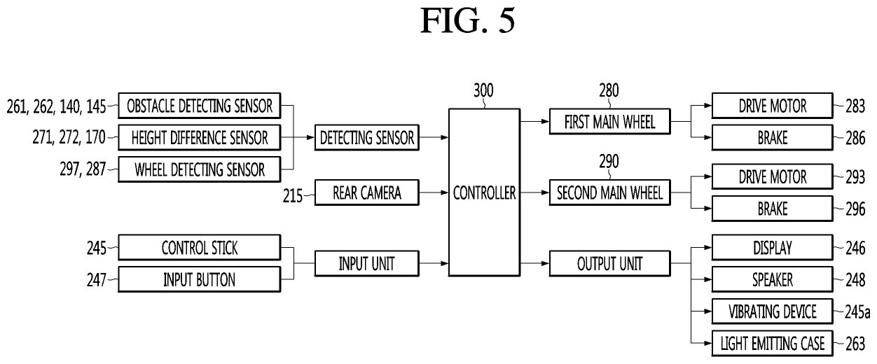

That is, the motorized wheelchair 1 may further include a controller 300 (FIG. 5) for controlling each component.

The control box 250 may include a box case 251 that protects the plurality of electronic parts. The box case 251 may extend from the front end of the low frame 230 to the rear end of the low frame 230 such that both side ends thereof are connected to the first side frame 221 and the second side frame 222. For example, the box case 251 may extend upward from the front end of the low frame 230 and be bent backward to be rounded, and then extend downward to the rear end of the low frame 230.

In addition, a board plate to which the plurality of electronic parts are connected may be located in an inner space formed by the box case 251.

The rear obstacle detecting sensor 261 or 262 may be installed in the control box 250. In detail, the rear obstacle detecting sensor 261 or 262 may be installed in the rear surface of the box case 251. The rear obstacle detecting sensor 261 or 262 may be connected to the box case 251 to be exposed to the outside.

The rear obstacle detecting sensors 261 and 262 may be disposed at a higher position than the rear height difference sensors 161 and 162.

The rear obstacle detecting sensors 261 and 262 may include an ultrasonic sensor (USS). The ultrasonic sensor USS may include an ultrasonic sensor that senses a distance.

Since the low frame 230 may extend to be inclined in the front-rear direction, the rear surface of the box case 251 may also have a predetermined inclination angle θ with the ground. For example, the low frame 230 and the rear surface of the box case 251 may have a shape of ‘<’ when viewed from the side.

Therefore, the rear obstacle detecting sensors 261 and 262 may be installed at a higher position than the rear end of the low frame 230. Accordingly, the rear obstacle detecting sensors 261 and 262 may sense the rear area of the motorized wheelchair 1 more widely at a higher position.

The rear obstacle detecting sensors 261 and 262 may be provided in plurality. For example, the rear obstacle detecting sensors 261 and 262 may include a first rear obstacle detecting sensor 261 and a second rear obstacle detecting sensor 262 laterally spaced apart from the first rear obstacle detecting sensor 261.

The rear obstacle detecting sensors 261 and 262 may further include a light emitting case 263.

The lighting case 263 may be provided with an LED. Therefore, the light emitting case 263 may provide light according to an operation mode of the motorized wheelchair 1. For example, the light emitting case 263 may provide light in various colors according to various operating environments, such as whether the rear obstacle is detected, whether the brake of the motorized wheelchair 1 is operated, or whether it is reversed.

The light emitting case 263 may be located in the rear surface of the box case 251. The light emitting case 263 may be connected to the box case 251 to cover the first rear obstacle detecting sensor 261 and the second rear obstacle detecting sensor 262.

The light emitting case 263 may formed with an opening through which the first rear obstacle detecting sensor 261 and the second rear obstacle detecting sensor 262 ate exposed to the outside. The light emitting case 263 may elongate in both directions to cover both the first rear obstacle detecting sensor 261 and the second rear obstacle detecting sensor 262.

The inner surfaces of the side frames 221 and 222 may be provided with a bracket that connects a wheel shaft (not shown) and the wheel shaft that support the main wheels 280 and 290.

The bracket may be connected to the side frames 221 and 222 to fix the wheel shaft. For example, the wheel shaft and the bracket may be connected to inner surfaces of the lower portions of the side frames 221 and 222.

The wheel shaft may extend outwardly through the main wheel coupling holes 221d. As an example, the wheel shaft may be exposed to the outside through the outer surfaces of lower portions of the side frames 221 and 222.

The wheel shaft may be connected to the drive motors 283 and 293 of the main wheels 280 and 290. As an example, the wheel shaft may be connected to stators of the drive motors 283 and 293.

The main wheels 280 and 290 may be located at both lower ends of the back frame 200. That is, the main wheels 280 and 290 may be connected to the lower portions of the side frames 221 and 222 to provide a force for running of the motorized wheelchair 1.

The main wheel 280 may include the first main wheel 280 and the second main wheel 290.

The first main wheel 280 may be installed below the first side frame 221. The second main wheel 290 may be installed below the second side frame 222.

In detail, the first main wheel 280 may be connected to a wheel shaft connected to the first side frame 221. The second main wheel 290 may be connected to a wheel shaft connected to the second side frame 222.

Meanwhile, each of the main wheels 280 and 290 may include a wheel case 281, a tire 285, a drive motor 283 or 293 (see FIG. 5), a wheel detecting sensor 287 or 297 (see FIG. 5), and a brake 286 or 296 (see FIG. 5).

The wheel case 281 may be provided to cover an upper portion of the tire 285.

The drive motor 283 may receive power from the battery. The drive motors 283 and 293 may provide driving force to rotate the main wheels 280 and 290. That is, the main wheels 280 and 290 may perform rolling motion by the operation of the drive motors 283 and 293.

As a result, the motorized wheelchair 1 may run on the ground by driving the main wheels 280 and 290. In addition, since the sub wheels 181 and 182 are dependent on the driving of the main wheels 280 and 290 to perform rolling motions, the sub wheels 181 and 182 may assist the motorized wheelchair 1 in running stably.

The drive motors 283 and 293 may be connected to wheel shafts (not shown) connected to the side frames 221 and 222. In addition, the drive motors 283 and 293 may include an outer rotor type. As an example, stators of the drive motors 283 and 293 may be connected to the wheel shafts. The rotors of the drive motors 283 and 293 may be disposed to surround the outer circumferences of the stators to rotate.

The drive motors 283 and 293 may include a first drive motor 283 provided in the first main wheel 280 and a second drive motor 293 provided in the second main wheel 290.

The main wheels 280 and 290 may include a rim extending in a radial direction from the rotors of the drive motors 283 and 293. The tire 285 may be installed along the outer circumference of the rim.

The brakes 286 and 296 may be installed on the rims. Therefore, when the brakes 286 and 296 are operated, the rotation of the main wheels 280 and 290 may be stopped quickly.

The brakes 286 and 296 may include a first brake 286 provided in the first main wheel 280 and a second brake 296 provided in the second main wheel 290.

The wheel detecting sensors 287 and 297 may be provided to detect the rotational states of the main wheels 280 and 290. For example, the wheel detecting sensors 287 and 297 may detect rotational speeds of the main wheels 280 and 290. As an example, the wheel detecting sensors 287 and 297 may be connected to the side frames 221 and 222 at positions on one side corresponding to the rotors of the drive motors 283 and 293. The wheel detecting sensors 287 and 297 may include a Hall sensor.

The motorized wheelchair 1 may further include armrests 241 and 242 connected to the outer surface of the back frame 200.

The armrests 241 and 242 may be portions supporting the user's arms or hands. The armrests 241 and 242 may have a triangular shape and may be rotatably connected to both sides of the back frame 200, respectively. For example, the armrests 241 and 242 may be hinged to the back frame 200.

The armrests 241 and 242 may include a first armrest 241 connected to a first side frame 221 and a second armrest 242 connected to a second side frame 222. For example, the first armrest 241 may support the user's right arm, and the second armrest 242 may support the user's left arm.

The first armrest 241 may be rotatably connected to the armrest coupling hole 221b formed in the outer surface of the first side frame 221. The second armrest 242 may be rotatably connected to an armrest coupling hole (not shown) formed in an outer surface of the second side frame 222.

The motorized wheelchair 1 may further include input units 245 and 247 for receiving a user input and output units 246 and 248 for outputting information.

The input units 245 and 247 and the output units 246 and 248 may be installed on the armrests 241 and 242. For example, the input units 245 and 247 and the output units 246 and 248 may be installed on the first armrest 241 or the second armrest 242.

The input units 245 and 247 and the output units 246 and 248 may be detachably connected to the armrests 241 and 242. For example, the input units 245 and 247 and the output units 246 and 248 may be formed as one module. The input units 245 and 247 and the output units 246 and 248 may be configured to be fitted rearward from front ends of the armrests 241 and 242.

Therefore, when the user is right-handed, the input units 245 and 247 and the output units 246 and 248 may be easily installed on the first armrest 241. On the contrary, when the user is left-handed, the input units 245 and 247 and the output units 246 and 248 may be easily removed from the first armrest 241 frontward and installed on the second armrest 242.

The input units 245 and 247 may include the control stick 245 for controlling a running direction, a speed, and the like of the motorized wheelchair 1.

The control stick 245 may be provided to be able to move up, down, left and right and rotate 360 degrees. The control stick 245 may control movement directions of the main wheels 280 and 290.

That is, the control stick 245 may be understood as a steering device of the motorized wheelchair 1. Therefore, the user may determine the running direction of the motorized wheelchair 1 by moving the stick while holding the stick.

In addition, the user may increase the rotational speed of the main wheels 280 and 290 by maintaining the control stick 245 in a moving state for a predetermined time in a direction that matches the running direction of the motorized wheelchair 1. In addition, when the user maintains the control stick 245 in a direction opposite to the running direction of the motorized wheelchair 1 by 180 degrees for a predetermined time, it is possible to decrease the rotational speed of the main wheels 280 and 290. Accordingly, the user may simply control the speed and the running direction of the motorized wheelchair 1.

In addition, the control stick 245 may be provided with a vibrating device 245a. In addition, the vibrating device 245a may operate by receiving a command signal from the controller 300. For example, when an obstacle is detected during running of the motorized wheelchair 1 or a height difference is detected on the running surface, the controller 300 may generate vibration in the control stick 245 by operating the vibrating device 245a.

Accordingly, the user may perceive risk information by tactile sense.

In addition, the input units 245 and 247 may further include an input button 247 formed in front of the control stick 245.

The input button 247 may be provided so as to allow a user to easily input various convenience functions of the motorized wheelchair 1.

Of course, the control stick 245 may be provided with a plurality of input buttons. The buttons provided in the control stick 235 may be used as an input device for control convenience for the user.

The output units 246 and 248 may include a display 246 that displays visual information and a speaker 248. The display 246 may be located at the front end of the armrest 241 or 242. The display 246 may be installed to be inclined upward from the front end of the armrest 241 or 242. Accordingly, the direction of the display 246 coincides with the user's gaze direction which is directed downward, thus enabling the user to comfortably check the display 246.

The display 246 may display various information of the motorized wheelchair 1. For example, the display 246 may output various screens such as a running speed, a running path, whether an obstacle is detected, whether a height difference is detected, a warning message, a user input menu or the like of the motorized wheelchair 1.

The controller 300 may determine an environment that may adversely affects safety while running of the motorized wheelchair 1 based on detection signals received from the obstacle detecting sensors 140, 145, 261 and 262, the height difference sensors 170, 271 and 272 and the rear camera 215, and allow the display 246 to display risk information. Accordingly, the user may recognize the risk information visually.

In addition, the display 246 may include a touch type display capable of enabling a touch input. For example, the user may check a message output on the display 246 and perform a related input by touching at least one of the display 246, the input button 247, and the control stick 245.

The speaker 248 may be installed together on a cover accommodating the display 246. As one example, the speaker 248 may be located behind the display 246. Of course, the installation position of the speaker 248 is not limited thereto.

The speaker 248 may be operated by receiving a command signal from the controller 300. For example, when an obstacle is detected in the running direction of the motorized wheelchair 1, the controller 300 may allow the speaker 248 to output sounds having different frequencies and magnitudes according to a distance from the obstacle that is approaching. In this way, the user may perceive the risk information by hearing.

That is, the motorized wheelchair 1 according to an embodiment of the present disclosure may provide a plurality of notification means 235, 246, and 248 that allow the user to recognize risk factors during running with the user's tactile, visual, and auditory senses which are determined by the plurality of detecting sensors 140, 145, 170, 261, 262, 271, 272, and 215.

Therefore, even when one of the sensory organs does not function properly in terms of the characteristics of the user who uses the motorized wheelchair 1, the motorized wheelchair 1 may be safely operated and driven.

The front obstacle detecting sensors 140 and 145 and the front height difference sensor 170 may be referred to as a “front detecting sensor”. In addition, the rear obstacle detecting sensors 261 and 262, the rear height difference sensors 271 and 272 and the rear camera 215 may be referred to as a “rear detecting sensor”.

Referring to FIG. 4, the motorized wheelchair 1 according to an embodiment of the present disclosure may include a first part 10 and a second part 20 which are detachably connected to each other.

The first part 10 may be configured to support the lower body of the user, and the second part 20 may be configured to support the upper body of the user.

Accordingly, the first part 10 may be referred to as a “seating part”, and the second part 20 may be referred to as a “backrest part”.

The first part 10 may include the seat frame 100, the seat assembly 150, the foot guide 160, and the sub wheels 181 and 182.

In addition, the front detecting sensors 140, 145, and 170 may be installed in the first part 10.

The second part 20 may include the back frame 200, the back plate 211, the cushion 212, the guide plate 225, the armrests 241 and 242, the control stick 245, the display 246, the input button 247, the speaker 248, the control box 250, and the main wheels 280 and 290.

The rear detecting sensors 261, 262, 271, and 272 may be installed in the second part 20.

The motorized wheelchair 1 may connect or separate the first part 10 to or from the second part 20 depending on whether the motorized wheelchair 1 is used. For example, when the motorized wheelchair 1 is used, the first part 10 may be slidably inserted into the second part 20. On the other hand, when the motorized wheelchair 1 is not used, the first part 10 may be slidably drawn out from the second part 20.

Accordingly, the first part 10 may be easily separated from and the second part 20, thus facilitating the storage and transportation of the motorized wheelchair 1.

In addition, the separated first part 10 may be fitted into the second part 2 in a state of being stacked on the second part 20. Accordingly, since the total volume of the motorized wheelchair 1 becomes small, the motorized wheelchair 1 may be stored in a relatively small space.

Meanwhile, the first part 10 and the second part 20 may be electrically connected to each other only when the first part 10 is completely inserted into the second part 20. That is, the first part 10 and the second part 20 may be provided in a switch structure that is turned on and off (ON/OFF) to conduct electricity depending on whether they are connected to each other.

For example, the first part 10 may have a contact formed in the seat frame 100 supporting the seat assembly 150. The second part 20 may have a contact formed in the insertion groove 221a into which the seat frame 100 is slidably inserted.

Therefore, when the first part 10 and the second part 20 are connected to each other, the contact of the first part 10 is in contact with the contact of the second part 20, so that an on state in which electricity is conducted is achieved. In addition, the motorized wheelchair 1 may operate normally when the first part 10 and the second part 20 are electrically connected to each other.

On the other hand, when the first part 10 and the second part 20 are separated from each other, the contact of the first part 10 is not in contact with the contact of the second part 20, so that an off state in which electricity is not conducted is achieved.

Accordingly, since the electrical connection between the first part 10 and the second part 20 is broken when the first part 10 and the second part 20 are separated from each other, it is impossible to force the motorized wheelchair to operate. As a result, the safety of the motorized wheelchair 1 may be improved.

FIG. 5 is a block diagram showing a control configuration of a motorized wheelchair according to an embodiment of the present disclosure.

Referring to FIG. 5, in order to control the motorized wheelchair 1, a detecting sensor and an input unit provided in the motorized wheelchair 1 may provide information to the controller 300. Accordingly, the controller 300 may control operations of the main wheels 280 and 290 and the output unit based on the information.

The detecting sensor may include a front obstacle detecting sensor 140 and 145, the front height difference sensor 170, the rear obstacle detecting sensors 261 and 262, the rear height difference sensors 271 and 272 and the wheel detecting sensors 287 and 297.

The detecting sensor may detect risk factors of the surroundings for the safe driving of the motorized wheelchair 1.

The obstacle detecting sensors 140, 145, 261 and 262 may be provided as ultrasonic sensors USS to detect whether obstacles exist around the motorized wheelchair 1. Accordingly, the motorized wheelchair 1 may be prevented from colliding with a surrounding obstacle.

In addition, the height difference sensors 170, 271 and 272 are provided as a distance detecting sensor (PSD) to detect a height difference of the ground on which the motorized wheelchair 1 moves. Accordingly, the motorized wheelchair 1 may be prevented from running on the ground with a height difference greater than or equal to a set reference.

In addition, the wheel detecting sensors 287 and 297 may be provided as Hall sensors to detect operating states of the main wheels 280 and 290. Accordingly, it is possible to determine the rotational speed of the drive motors 283 and 293, whether or not over-current occurs.

In addition, the controller 300 may receive a captured image of the rear camera 215 and allow the output unit to output the rear image of the motorized wheelchair 1.

The input unit may include the control stick 245 and the input button 247.

The control stick 245 may be provided to adjust the running direction and the speed of the motorized wheelchair 1 while the user holds the control stick 245.

That is, the running direction of the motorized wheelchair 1 may be determined along the operation direction of the control stick 245.

The user may input a turning motion of the motorized wheelchair 1 by operating the control stick 245. The controller 300 may control the main wheels 280 and 290 by determining a turning direction so as to correspond to an operation direction of the control stick 245.

In addition, the control stick 245 may be provided with a vibrating device 245a to stimulate the user's tactile sense. For example, the controller 300 may allow the vibrating device 245a to vibrate based on information input from the detecting sensor, thus enabling the user to tactilely recognize a risk factor of surroundings.

The input button 247 may be provided in plurality. In addition, the input button 247 may be provided to facilitate the user's operation of various functions of the motorized wheelchair 1, such as ON/OFF of the battery power, switching of screens output to the display 246, heating operation provided in the seat 152, running route guidance or the like.

The output unit may include the display 246, the speaker 248, the vibrating device 245a, and the light emitting case 263. The display 246 may provide visual information to the user, and the speaker 248 may provide audio information to the user.

The controller 300 may control the display 236 and the speaker 248 based on information received from the input unit and/or the detecting sensor. For example, the controller 300 may allow the display 246 to output a warning text, a rear image, a running guidance screen, and the like.

In addition, the controller 300 may allow the speaker 248 to output a warning sound, a voice guidance, or the like.

In addition, the controller 300 may operate the light emitting diode to light a warning light in the light emitting case 263.

In addition, the controller 300 may control the vibrating device 245a such that the vibration intensity or the vibration interval of the control stick 245 is adjusted.

In addition, the controller 300 may control operations of the main wheels 280 and 290 based on information input from the input unit and/or the detecting sensor. As an example, the controller 300 may control the drive motors 283 and 293 of the main wheels 280 and 290 to reduce the speed based on information on an obstacle detected by the obstacle detecting sensor 140, 145, 261 or 262.

In addition, the controller 300 may operate the brakes 286 and 296 of the main wheels 280 and 290 to perform emergency braking based on the detected obstacle information. Accordingly, it is possible to prevent the collision between the motorized wheelchair 1 and the obstacle even when the user does not recognize the obstacle.

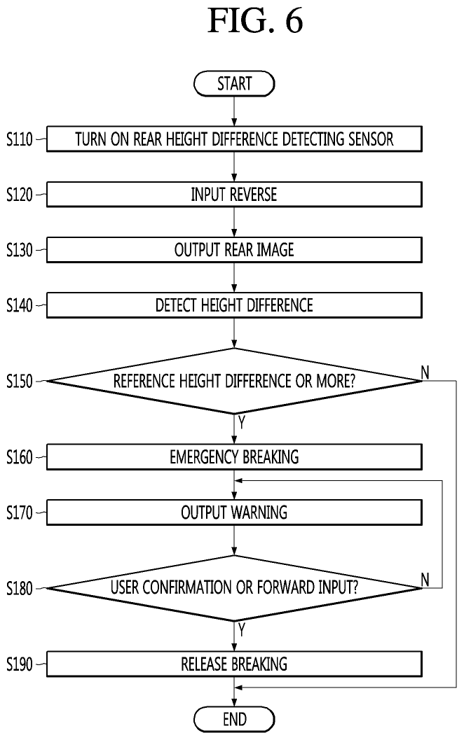

FIG. 6 is a flow chart showing a rear height difference risk prevention control for a motorized wheelchair according to an embodiment of the present disclosure.

The rear height difference risk prevention control may be understood as a control for preventing an accident such as overturning due to a height difference of the ground when the motorized wheelchair 1 moves backward.

Referring to FIG. 6, the rear height difference sensors 271 and 272 may be operated to detect a height difference (or a step) of the ground on the rear side of the motorized wheelchair 1. That is, the motorized wheelchair 1 may turn on the power supply of the rear height difference sensors 271 and 272. As an example, the controller 300 may perform control to supply power to the rear height difference sensors 271 and 272 from the battery (S110).

In addition, for reverse of the motorized wheelchair 1, a reverse command may be input to the controller 300. For example, the user may input a reverse command of the motorized wheelchair 1 through the input unit to allow the motorized wheelchair 1 to run backward (S120).

Of course, the rear height difference sensors 271 and 272 may sense the rear ground of the motorized wheelchair 1 regardless of the forward or reverse of the motorized wheelchair 1.

The motorized wheelchair 1 may output a rear image of the motorized wheelchair 1 to the display 236 for reverse after a reverse input (S130).

In detail, when the reverse input is received, the controller 300 may allow the display 246 to output an image captured by the rear camera 215 to the display 246. Due to this, it is possible for user to move backward more safely.

In addition, the rear height difference sensors 271 and 272 may detect a height difference (or a step) of the rear ground, which exists in the running direction of the motorized wheelchair 1 (S140).

In detail, the rear height difference sensors 271 and 272 may detect the height difference based on a signal returned by emitting infrared rays toward the rear ground of the motorized wheelchair 1. The rear height difference sensors 271 and 272 may provide a detection signal for the height difference to the controller 300.

Here, the rear height difference sensors 271 and 272 may detect a wider area of the ground by the low frame 230 disposed to be inclined.

When a height difference of the ground is detected during the reverse of the motorized wheelchair 1, the motorized wheelchair 1 may determine whether the detected height difference (height difference) is greater than or equal to a preset reference height difference (S150).

That is, the controller 300 may determine whether there is a risk of overturning of the motorized wheelchair 1 based on the detection signal provided from the rear height difference sensor 271 or 272.

The reference height difference may be set to a smaller one of the maximum value of a height difference (step) over which the motorized wheelchair 1 is able to run without overturning and a distance between a bottom surface of the foot guide 160 and the flat surface.

When the detected height difference is greater than or equal to the reference height difference, the motorized wheelchair 1 may perform emergency braking (S160).

In detail, when the detected height difference is determined to be greater than or equal to the reference height difference, the controller 300 may allow the brakes 286 and 296 of the main wheels 280 and 290 to operate. Therefore, the rotation of the main wheels 280 and 290 may be stopped quickly to allow the motorized wheelchair 1 to stop.

The motorized wheelchair 1 may output a warning for the height difference (the step) of the rear ground through at least one of the display 246, the speaker 248, the control stick 245, and the light emitting case 263 (S170).

For example, the controller 300 may allow the display 246 to output a warning screen indicating that a height difference greater than or equal to the reference height difference is located behind.

In addition, the controller 300 may allow the speaker 248 to output a warning sound and/or a warning guidance as a speech.

In addition, the controller 300 may output a warning by allowing the vibrating device 245a provided in the control stick 245 to operate.

Due to this, the user may recognize the fact that the height difference is detected through at least one of sight, hearing, and tactile sense.

In addition, the controller 300 may allow the warning light of the light emitting case 263 to flicker. Due to this, it is possible to provide a warning for running of the motorized wheelchair 1 to the people behind the motorized wheelchair 1.

In addition, the motorized wheelchair 1 may determine whether a user confirmation or forward running is input (S180).

Specifically, when the warning is output due to a malfunction or the like, the user may identify whether the detected height difference is actually a dangerous height difference and then operate the input unit such that the motorized wheelchair 1 continuously runs backward. For example, the user may take a selection for continuous running on the warning screen output to the display 246. In addition, the user may push the control stick 245 backward to input a reverse signal. In addition, the user may press the reverse button provided in the input button 247 to input the reverse signal.

In this case, the operation of the input unit for the reverse of the motorized wheelchair 1 may be referred to as “user confirmation input”.

Alternatively, the user may operate the input unit to drive the motorized wheelchair 1 forward to avoid the height difference. In one example, the user may select a forward on the warning screen output on the display 246. In addition, the user may input a forward signal by pulling the control stick 245 forward. In addition, the user may press a forward button provided in the input button 247 to input the forward signal.

The above-mentioned user's operation of the input unit to drive the motorized wheelchair 1 forward may be referred to as “forward input”.

When it is determined that there is no user confirmation or forward input, the stopped state of the motorized wheelchair 1 may be maintained.

On the contrary, when it is determined that there is the user confirmation input or forward input, the motorized wheelchair 1 may release a braking state. The motorized wheelchair 1 may end the warning (S190).

In detail, when the user confirmation is performed, the controller 300 may release the operation of the brakes 286 and 296 and control the drive motors 283 and 293 to normally rotate (reversely rotate) for the reverse operation. Therefore, the reverse running of the motorized wheelchair 1 may be continuously maintained.

On the other hand, when the forward input is performed, the controller 300 may release the operation of the brakes 286 and 296 and allow the drive motors 283 and 293 to rotate forward. Therefore, the motorized wheelchair 1 may run forward.

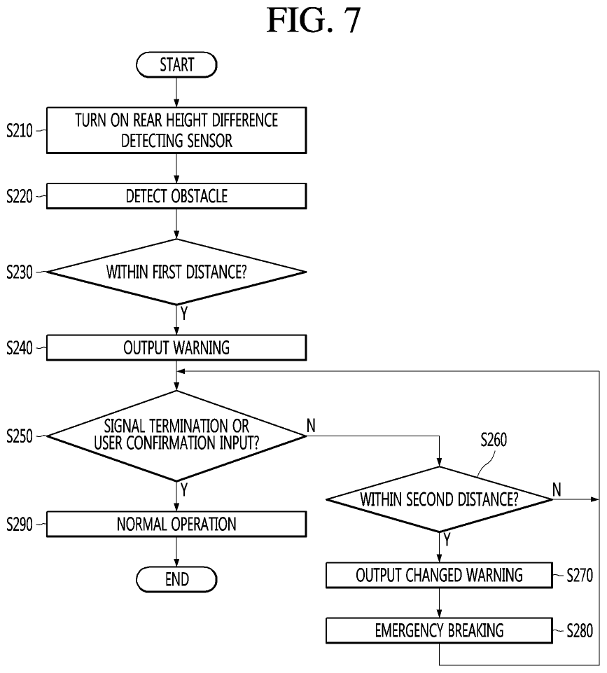

FIG. 7 is a flow chart showing rear obstacle risk prevention control of the motorized wheelchair according to an embodiment of the present disclosure.

The rear obstacle risk prevention control may be understood as a control for preventing a collision with an obstacle on the rear side of the motorized wheelchair 1.

The rear obstacle risk prevention control may be performed together with the rear height difference risk prevention control described above. In addition, when the rear height difference sensors 171 and 172 are in an off state, the motorized wheelchair 1 may perform the rear obstacle risk prevention control alone.

Referring to FIG. 7, the motorized wheelchair 1 may operate rear obstacle detecting sensors 261 and 262 to detect rear obstacles.

That is, the motorized wheelchair 1 may turn on the power supply of the rear obstacle detecting sensors 261 and 262. For example, the controller 300 may perform control to supply power to the rear obstacle detecting sensors 261 and 262 from the battery (S210).

Meanwhile, the rear obstacle detecting sensors 261 and 262 may operate regardless of the running direction of the motorized wheelchair 1.

The rear obstacle detecting sensors 261 and 262 may detect an obstacle located in a rear area of the motorized wheelchair 1 (S220).

In detail, the rear obstacle detecting sensors 261 and 262 may detect obstacles behind based on a signal returned by emitting ultrasonic waves toward the rear of the motorized wheelchair 1. When the rear obstacle detecting sensors 261 and 262 detect an obstacle, the rear obstacle detecting sensors 261 and 262 may provide the obstacle detection signal to the controller 300.

In addition, the motorized wheelchair 1 may determine whether a distance to the detected obstacle is within a first distance (S230).

In detail, the controller 300 may calculate a distance between the obstacle and the motorized wheelchair 1 based on the detection signal received from the rear obstacle detecting sensor 261 or 262. The controller 300 may determine whether the calculated distance is within the first distance that is preset.

Here, the first distance may be set differently according to the running direction of the motorized wheelchair 1 as a distance at which warning is required for the user.

For example, the first distance may be set to a value between about 1 m to 2 m when the motorized wheelchair 1 moves backward. In addition, the first distance may be set to a value within about 1 m when the motorized wheelchair 1 moves forward.

When the distance to the obstacle is within the first distance, the motorized wheelchair 1 may output a warning (S240).

In detail, the controller 300 may output a warning about a rear obstacle through at least one of the display 246, the speaker 248, the light emitting case 263, and the control stick 245.

For example, the controller 300 may control the display 246 to output a warning screen indicating that there is an obstacle behind.

In addition, the controller 300 may allow the speaker 248 to output a warning sound and/or a warning guidance as a speech.

In addition, the controller 300 may output a warning by allowing the vibrating device 245a provided in the control stick 245 to operate.

Accordingly, the user may recognize the fact that the obstacle is detected through at least one of sight, hearing, and tactile sense.

In addition, the controller 300 may allow the warning light of the light emitting case 263 to flicker. Due to this, it is possible to provide a warning for running of the motorized wheelchair 1 to the people behind the motorized wheelchair 1.

In addition, the motorized wheelchair 1 may determine whether the obstacle detection signal by the rear obstacle detecting sensors 261 and 262 is terminated or whether the user confirmation input occurs (S250).

For example, when the rear obstacle is a person that is moving, the obstacle detection signal may be terminated from the rear obstacle detecting sensors 261 and 262 after a predetermined time elapses.

In addition, when it is determined that the running is sufficiently performed, or when the warning is output due to a malfunction or the like, the user may operate the input unit such that the motorized wheelchair 1 continues to run after actually identifying the obstacle. That is, the user may perform a user confirmation input.

The motorized wheelchair 1 may continue running normally when the obstacle detection signal is not received or a user confirmation input is performed (S290).

However, when the obstacle detection signal is not received or the user confirmation input is not performed, the motorized wheelchair 1 may determine whether the distance to the obstacle is within a second distance (S260).

In detail, the controller 300 may continuously calculate the distance to the obstacle based on detection signals input from the rear obstacle detecting sensors 261 and 262. That is, the controller 300 may determine whether the distance between the motorized wheelchair 1 and the obstacle is within the second distance based on the information provided from the rear obstacle detecting sensors 261 and 262.

The second distance may be previously set to a distance shorter than the first distance. For example, the second distance may be set to about 50 cm when the motorized wheelchair 1 moves forward. In addition, the second distance may be set to a value between about 50 cm and 1.5 when the motorized wheelchair 1 moves backward.

When it is determined that the distance is within the second distance, the motorized wheelchair 1 may change and output a warning (S270).

In detail, when the distance is determined to be within the second distance, the controller 300 may change the warning through at least one of the display 246, the speaker 248, the light emitting case 263, and the control sticks 245 to provide warning to the rear obstacle for gradual approach.

For example, the controller 300 may perform control to enable a warning screen output to the display 246 to flicker or output a flickering screen on which red light is flickering.

In addition, the control unit 300 may perform control to speed up the interval of the warning sound output to the speaker 248 or to change the speech of the warning guidance.

In addition, the controller 300 may perform control to speed up the operation interval of the vibrating device 245a or increase the vibration intensity.

Due to this, the user may recognize the fact that the obstacle approaches through at least one of sight, hearing, and tactile sense.

In addition, the controller 300 may control the light emitting diode (LED) provided in the light emitting case 263 so as to change or blink the color of lighting. Accordingly, the people who are located behind the motorized wheelchair 1 may be warned of the running of the motorized wheelchair 1.

In addition, when it is determined that the second distance is reached, the motorized wheelchair 1 may perform emergency braking to prevent a collision with the rear obstacle (S280).

In detail, when the distance to the rear obstacle is determined to be within the second distance, the controller 300 may allow the brakes 286 and 296 of the main wheels 280 and 290 to operate. Therefore, the rotation of the main wheels 280 and 290 may be stopped quickly to allow the motorized wheelchair 1 to stop. Accordingly, it is possible to prevent the collision with the rear obstacle or minimize the impact thereof. Thereafter, returning to step S250 may be performed.

What is claimed is:

1. A motorized wheelchair comprising:
a seat assembly on which a user is able sit;
a seat frame supporting the seat assembly;
a back frame detachably connected to both sides of the seat frame;
a control box located in an inner space formed by a lower portion of the back frame;
main wheels respectively connected to both lower ends of the back frame;
a rear obstacle detecting sensor installed at a rear of the control box; and
a rear height difference sensor installed on the back frame to be inclined upward toward the ground.

2. The motorized wheelchair of claim 1, wherein the back frame includes
an upper frame to which a backrest is connected in front thereof;
side frames extending to be inclined downward from both side ends of the upper frame; and
a low frame connecting lower ends of the side frames and installed with the rear height difference sensor.

3. The motorized wheelchair of claim 2, wherein the low frame extends such that a rear end is higher than a front end.

4. The motorized wheelchair of claim 2, further comprising a rear camera installed on a rear surface of the upper frame.

5. The motorized wheelchair of claim 2, wherein the side frames are formed with an insertion groove for guiding insertion of the seat frame.

6. The motorized wheelchair of claim 5, wherein the side frame is located under the insertion groove and includes a curved portion extending inward to form a space in which the main wheel is mounted.

7. The motorized wheelchair of claim 1, further comprising:
armrests rotatably connected to both sides of the back frame; and
an input unit and an output unit detachably installed to the armrests.

8. The motorized wheelchair of claim 7, wherein the input unit is provided with a vibrating device therein and includes a control stick for operating movement.

9. The motorized wheelchair of claim 7, wherein the output unit includes a display that provides a screen and a speaker that provides a sound.

10. The motorized wheelchair of claim 1, further comprising:
a light emitting case installed on the rear surface of the control box to cover the rear obstacle detecting sensor and provided with a light emitting diode.

11. The motorized wheelchair of claim 1, wherein the rear height difference sensor located at a most rear of the back frame.

12. A method of controlling a motorized wheelchair, the motorized wheelchair including a seat frame provided with a seat for seating of a user, a back frame provided with a backrest for supporting the user's back and detachably connected to the seat frame, and main wheels connected to a lower end of the back frame, the method comprising:
inputting a reverse command to an input unit;
outputting an image photographed by a rear camera installed in the back frame to an output unit;
detecting, by a rear height difference sensor installed in bottom of the back frame, a height difference in the ground;
determining whether the height difference detected by the rear height difference sensor is larger than or equal to a preset reference height difference;
performing an emergency braking defined as activating a brake of the main wheels when the detected height difference is larger than or equal to the reference height difference; and
outputting a warning about the detected height difference to the output unit.

13. The method of claim 12, wherein the input unit includes a control stick for controlling running and a plurality of input buttons.

14. The method of claim 13, wherein the output unit includes a display that provides a screen, a speaker that provides a sound, and a vibrating device provided in the control stick.

15. The method of claim 14, wherein the warning is output by at least one of the display, the speaker and the vibrating device.

16. The method of claim 14, wherein the outputting of the warning includes a warning screen to the display, a warning sound output to the speaker, a speech guidance and a vibration by the vibrating device.

17. The method of claim 12, further comprising:
determining whether a user confirmation or a forward is input for running straight after output of the warning.

18. The motorized wheelchair of claim 17, further comprising:
releasing operation of the break when the user confirmation or the forward is input.

19. The method of claim 12, further comprising:
detecting an obstacle by an obstacle detecting sensor installed on a rear surface of a control box connected to the back frame; and
determining whether the detected obstacle is positioned within a preset first distance,
outputting a warning for the detected height difference to the output unit when the detected obstacle is within the first distance.

20. The method of claim 19, further comprising:
changing the output warning when the detected obstacle is within a second distance shorter than the first distance.
